(19) United States
(12) Patent Application Publication
(10) Pub. No.: US 2026/0121291 A1
(43) Pub. Date: Apr. 30, 2026

(54) LOW SWITCH-COUNT ARCHITECTURE FOR MULTIPLE-ANTENNA ANTENNA SWITCH MODULE

(71) Applicant: SKYWORKS SOLUTIONS, INC., Irvine, CA (US)

(72) Inventors: Yuhao Lin, Cedar Rapids, IA (US); Tao Wu, Marion, IA (US); Jonathan Christian Crandall, Marion, IA (US)

(21) Appl. No.: 19/365,277

(22) Filed: Oct. 22, 2025

Related U.S. Application Data
(60) Provisional application No. 63/711,782, filed on Oct. 25, 2024.

(51) Int. Cl. H01Q 3/24; H01Q 1/50; H01Q 5/20

(52) U.S. Cl. CPC H01Q 3/24; H01Q 1/50; H01Q 5/20

(57) ABSTRACT

An antenna switch module including multiple band contacts including first, second, and third band contacts, multiple antenna contacts including first, second, and third antenna contacts, multiple intermediate electrical contacts including first and second intermediate electrical contacts, multiple band switches including first, second, and third band switches, and multiple antenna switches including first, second, and third antenna switches. Each of the first, second, and third band switches is coupled between one of the first, second, and third band contact and one of the first, second, and third intermediate electrical contact, respectively. The first antenna switch is coupled between the first intermediate electrical contact and the first antenna contact, the second antenna switch is coupled between the first intermediate electrical contact and the second antenna contact, and the third antenna switch is coupled between the second intermediate electrical contact and the third antenna contact.

### CROSS REFERENCE TO RELATED APPLICATIONS

This application claims priority, under 35 U.S.C. § 119, to U.S. Provisional Patent Application 63/711,782, titled LOW SWITCH-COUNT ARCHITECTURE FOR MULTIPLE-ANTENNA ANTENNA SWITCH MODULE, filed on October 25, 2024, said application being hereby incorporated by reference in its entirety for all purposes.

### BACKGROUND

### Technical Field

Aspects and embodiments of this disclosure relate to front end modules (FEMs) for transmitting and/or receiving Radio Frequency (RF) signals and more particularly to FEMs for transmitting and receiving multi-band RF signals using multiple antennas with a reduced number of switches.

### Description of Related Technology

Antenna switch modules (ASMs) are used in RF systems, such as cellular phones, tablets, computers, etc., to permit RF communications over various frequency bands using one or more different antennas. ASMs permit complex arrangements of amplifiers, filters, and antennas to be realized. However, as the complexity of the individual switch increases, so may the number of switches, which can increase the insertion loss of the ASM and increase the physical size of the circuits in which they are implemented.

### SUMMARY

According to an aspect of the present disclosure, an antenna switch module is provided. The antenna switch module includes a plurality of band contacts including first, second, and third band contacts, a plurality of antenna contacts including first, second, and third antenna contacts, a plurality of intermediate electrical contacts including first and second intermediate electrical contacts, a plurality of band switches including first, second, and third band switches, and a plurality of antenna switches including first, second, and third antenna switches. The first band contact is configured to communicate over at least one first frequency band, the second band contact is configured to communicate over at least one second frequency band, and the third band contact is configured to communicate over at least one third frequency band. The first band switch is coupled between the first band contact and the first intermediate electrical contact, the second band switch is coupled between the second band contact and the first intermediate electrical contact, and the third band switch is coupled between the third band contact and a second intermediate electrical contact. The first antenna switch is coupled between the first intermediate electrical contact and the first antenna contact, the second antenna switch is coupled between the first intermediate electrical contact and the second antenna contact, and the third antenna switch is coupled between the second intermediate electrical contact and the third antenna contact.

In one example, the antenna switch module further includes an electrical conductor electrically coupling the first intermediate electrical contact and the second intermediate electrical contact. In one example of the antenna switch module, the first intermediate electrical contact is disposed on a first module, the second intermediate electrical contact is disposed on a second module, and the electrical conductor is an electrically conductive strap.

In one example of the antenna switch module, the electrically conductive strap includes a multi-chip-module (MCM) strap external to the first module and the second module.

In another example of the antenna switch module, the electrically conductive strap includes an impedance matching network. In one example of the antenna switch module, the impedance matching network includes one of a pi-network, an L-network, or a T-network.

In one example of the antenna switch module, the first intermediate electrical contact and the second intermediate electrical contact are disposed on a same module, and the electrical conductor is formed by electrically conductive routing within the module. In one example of the antenna switch module, the electrically conductive routing includes an impedance matching network. In one example of the antenna switch module, the impedance matching network includes one of a pi-network, an L-network, or a T-network.

In one example, the antenna switch module further includes a plurality of shunt switches including a first shunt switch coupled to ground and between the first band contact and the first intermediate electrical contact, a second shunt switch coupled to ground and between the second band contact and the first intermediate electrical contact, and a third shunt switch coupled to ground and between the third band contact and the second intermediate electrical contact. In one example of the antenna switch module, the antenna switch module includes only 9 switch arms. In one example of the antenna switch module, the antenna switch module is implemented in silicon on insulator technology and occupies an area of approximately 0.290 mm² or less.

In one example, the antenna switch module further includes a fourth band contact to communicate over at least one fourth frequency band; a fourth antenna contact; a fourth band switch coupled between the fourth band contact and the second intermediate electrical contact; and a fourth antenna switch coupled between the second intermediate electrical contact and the fourth antenna contact.

In another example, the antenna switch module further includes a plurality of duplexers coupled to the first band contact, the plurality of duplexers including duplexers for at least bands 1 and 3, or bands 25, 66, and 30. In one example of the antenna switch module, the antenna switch module is implemented in a multi-chip module and wherein the multi-chip module includes at least one power amplifier and at least one low noise amplifier.

In one example of the antenna switch module, the third band switch is directly coupled to the second intermediate electrical contact.

According to another aspect of the present disclosure, in one example, a method of operating an antenna switch module is provided. The method includes coupling a first band contact to a first antenna contact through a first intermediate electrical contact, the first intermediate electrical contact switchably coupled to the first antenna contact and a second antenna contact, including operating a first band switch in a conducting state, the first band switch coupled between the first band contact and the first intermediate electrical contact, and operating a first antenna switch in a conducting state, the first antenna switch coupled between the first intermediate electrical contact and the first antenna contact; and coupling the first band contact to a second antenna contact through the first intermediate electrical contact and a second intermediate electrical contact, including operating a second antenna switch in a conducting state, the second antenna switch coupled between the second intermediate electrical contact and the second antenna contact.

In one example, the method further includes providing a conductive strap including an impedance matching circuit; and coupling the first intermediate electrical contact to the second intermediate electrical contact using the conductive strap.

In another example of the method, coupling the first band contact to the first antenna contact further includes operating a third band switch in a non-conducting state, the third band switch coupled between a third band contact and the first intermediate electrical contact.

In one example of the method, coupling the first band contact to the first antenna contact further includes operating a first shunt switch in a non-conducting state, the first shunt switch coupled between the first band contact and a reference node.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a schematic diagram of a mobile phone that can include a front end module in accordance with an example of the present disclosure;

FIG. 2 is a circuit diagram of a direct-connection type of antenna switch module that may be used in the front end module of FIG. 1 according to an example;

FIG. 3 is a circuit diagram of an enabled type of antenna switch module that may be used in the front end module of FIG. 1 according to an example;

FIG. 4 is a circuit diagram of a low-switch-count type of antenna switch module (ASM) that may be used in the front end module of FIG. 1 in accordance with an example of the present disclosure;

FIGS. 5A-5D illustrate circuit diagrams of a conductive strap of a low-switch-count ASM according to various examples;

FIG. 6A illustrates circuit schematic and small-signal equivalent circuit diagrams of the low-switch-count ASM of FIG. 4 in a mode where the first band contact is coupled to the first antenna contact according to an example;

FIG. 6B illustrates circuit schematic and small-signal equivalent circuit diagrams of the low-switch-count ASM of FIG. 4 in a high isolation state according to an example;

FIG. 6C illustrates circuit schematic and small-signal equivalent circuit diagrams of the low-switch-count ASM of FIG. 4 in a mode where the first band contact is coupled to the third antenna contact according to an example; and

FIG. 7 illustrates the low-switch-count ASM of FIG. 4 integrated into a multi-chip module that includes multiple filter modules and multiple discrete filters according to an example.

### DETAILED DESCRIPTION

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

Aspects of this disclosure can be implemented in various electronic devices. Examples of the electronic devices can include, but are not limited to, consumer electronic products, parts of the consumer electronic products such as packaged radio frequency modules, uplink wireless communication devices, wireless communication infrastructure, electronic test equipment, etc. Examples of the electronic devices can include, but are not limited to, a mobile phone such as a smart phone, a wearable computing device such as a smart watch or an ear piece, a telephone, a television, a computer monitor, a computer, a modem, a hand-held computer, a laptop computer, a tablet computer, a microwave, a refrigerator, a vehicular electronics system such as an automotive electronics system, a stereo system, a digital music player, a radio, a camera such as a digital camera, a portable memory chip, a washer, a dryer, a washer/dryer, a copier, a facsimile machine, a scanner, a multi-functional peripheral device, a wrist watch, a clock, etc. Further, the electronic devices can include unfinished products.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

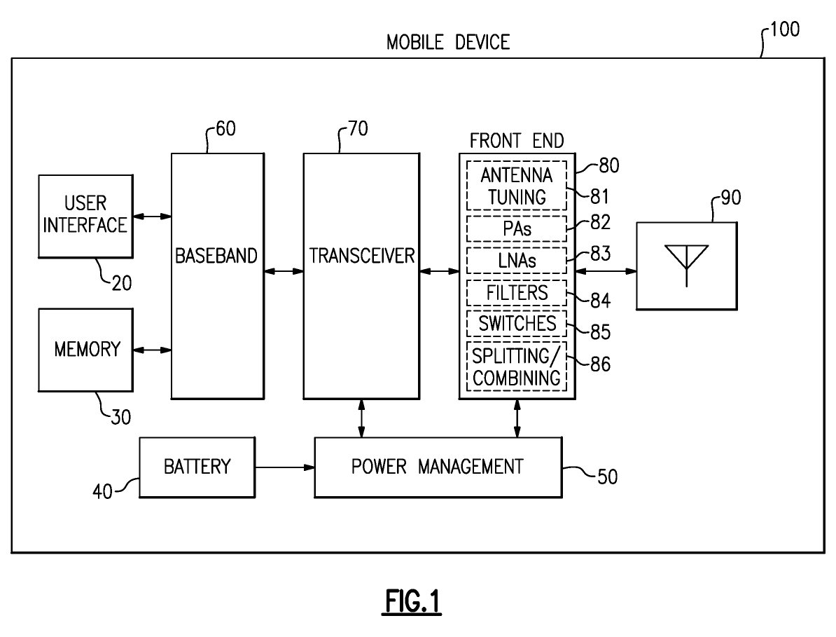

FIG. 1 is a schematic diagram of an exemplary mobile device that may include a front end module (FEM) in accordance with aspects of the present disclosure. A mobile device 100 includes a user interface 20, a memory 30, a battery 40, a power management system or module 50 (denoted as “POWER MANAGEMENT”), a baseband system or module 60 (denoted as “BASEBAND”), a transceiver 70, a front end system or module 80 (denoted as “FRONT END”), and antennas 90.

The mobile device 100 can be used to communicate using a wide variety of communication technologies, including, but not limited to, 2G, 3G, 4G (including LTE, LTE-Advanced, and LTE-Advanced Pro), 5G NR, WLAN (for instance, Wi-Fi), WPAN (for instance, Bluetooth and ZigBee), WMAN (for instance, WiMax), and/or GPS technologies.

The transceiver 70 generates RF signals for transmission and processes incoming RF signals received from the antennas 90. It will be understood that various functionalities associated with the transmission and reception of RF signals can be achieved by one or more components that are collectively represented in FIG. 1 as the transceiver 70. In one example, separate components (for instance, separate circuits or dies) in addition to the transceiver 70 can be provided for handling certain types of RF signals.

The front end system 80 aids in conditioning signals transmitted to and/or received from the antennas 90. In accordance with aspects of the present disclosure, the front end system 80 may be implemented in a single module (e.g., an FEM) and, in some embodiments, may be implemented on a single Silicon on Insulator (SOI) semiconductor die. In the illustrated embodiment, the front end system 80 includes antenna tuning circuitry 81, power amplifiers (PAs) 82, low noise amplifiers (LNAs) 83, filters 84, switches 85, and signal splitting/combining circuitry 86 (denoted as “SPLITTING/COMBINING”). However, other implementations are possible. The filters 84 may include one or more RF filters with different pass bands, duplexers, multiplexers, diplexers, and/or triplexers, etc.

The front end system 80 can provide a number of functionalities, including, but not limited to, amplifying signals for transmission, amplifying received signals, filtering signals, switching between different bands, switching between different power modes, switching between transmission and receiving modes, duplexing of signals, multiplexing of signals, or various combinations thereof.

In certain implementations, the mobile device 100 supports carrier aggregation, thereby providing flexibility to increase peak data rates. Carrier aggregation can be used for both Frequency Division Duplexing (FDD) and Time Division Duplexing (TDD) technologies, and may be used to aggregate multiple carriers or channels. Carrier aggregation includes contiguous aggregation, in which contiguous carriers within the same operating frequency band are aggregated. Carrier aggregation can also be non-contiguous, and can include carriers separated in frequency within a common band or across different bands.

The antennas 90 can include multiple antennas used for a wide variety of types of communications. For example, the antennas 90 can include antennas for transmitting and/or receiving signals associated with a wide variety of frequencies and communication standards.

In certain implementations, the antennas 90 support MIMO communications and/or switched diversity communications. For example, MIMO communications use multiple antennas for communicating multiple data streams over a single radio frequency channel. MIMO communications benefit from higher signal-to-noise ratios, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

In some implementations, the mobile device 100 can operate with beamforming. For example, the front end system 80 can include amplifiers having controllable gain and phase shifters having controllable phase to provide beam formation and directivity for transmission and/or reception of signals using the antennas 90. For example, in the context of signal transmission, the amplitude and phases of the transmit signals provided to the antennas 90 can be controlled such that radiated signals from the antennas 90 combine using constructive and destructive interference to generate an aggregate transmit signal exhibiting beam-like qualities with more signal strength propagating in a given direction. In the context of signal reception, the amplitude and phases of the signal can be controlled such that more signal energy is received when the signal is arriving at the antennas 90 from a particular direction. In certain implementations, the antennas 90 include one or more arrays of antenna elements to enhance beamforming.

The baseband system 60 is coupled to the user interface 90 to facilitate processing of various user input and output (I/O), such as voice and data. The baseband system 60 provides the transceiver 70 with digital representations of transmit signals, which the transceiver 70 processes to generate RF signals for transmission. The baseband system 60 also processes digital representations of received signals provided by the transceiver 70. As shown in FIG. 1, the baseband system 60 is coupled to the memory 30 to facilitate operation of the mobile device 100.

The memory 100 can be used for a wide variety of purposes, such as storing data and/or instructions to facilitate the operation of the mobile device 100 and/or to provide storage of user information.

The power management system 50 provides a number of power management functions of the mobile device 100. In certain implementations, the power management system 50 includes a PA supply control circuit that controls the supply voltage(s) of the power amplifiers 82. For example, the power management system 50 can be configured to change the supply voltage(s) provided to one or more of the power amplifiers 82 to improve efficiency, such as power added efficiency (PAE).

As shown in FIG. 1, the power management system 50 receives a battery voltage from the battery 40. The battery 40 can be any suitable battery for use in the mobile device 100, including, for example, a lithium-ion battery.

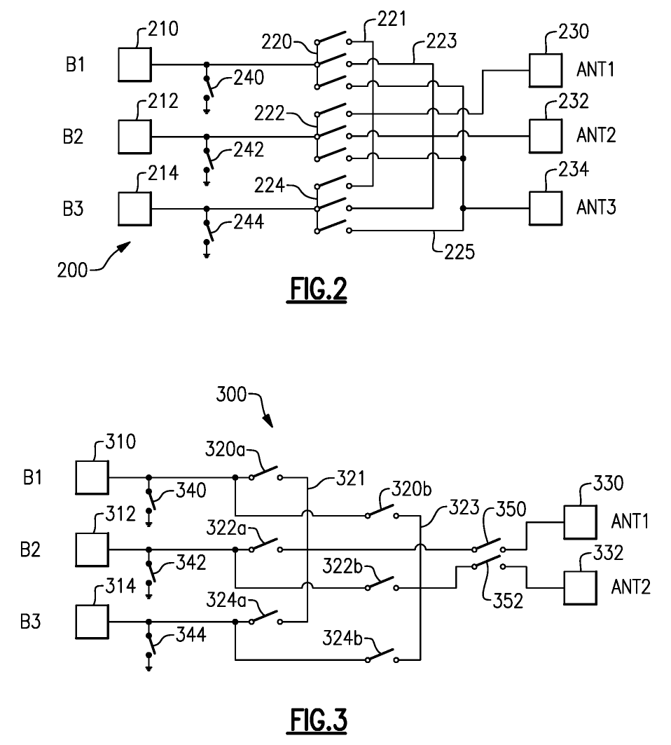

FIG. 2 illustrates a direct-connection type of antenna switch module (ASM) that might be used in a front end system, such as the front end system 80 of FIG. 1, according to an example. A direct-connection ASM 200 is configured as a triple-pole-triple-throw (3P3T) switch and can couple any one of three frequency band signals to any one of three different antennas. The direct-connection ASM 200 includes a first band contact or pad 210 for communicating (e.g., transmitting or receiving) signals in a first frequency band, a second band contact or pad 212 for communicating (e.g., transmitting or receiving) signals in a second frequency band, and a third band contact or pad 214 for communicating (e.g., transmitting or receiving) signals in a third frequency band. For example, the first band contact 210 may be configured to transmit and receive frequencies in bands 1, 3, 32, and 40, the second band contact 212 may be configured to transmit and receive frequencies in band 7, and the third band contact 214 may be configured to transmit and receive frequencies in bands 25, 66, and 30. While not shown in FIG. 2, the first band contact 210 may be connected to Band 1 and Band 3 duplexers, and to filters for each of bands 32 and 40. The second band contact 212 may be connected to a Band 7 duplexer, and the third band contact 214 may be connected to Band 25, 66, and 30 duplexers.

The direct-connection ASM 200 further includes a first single-pole-triple-throw (1P3T) switch 220, a second 1P3T switch 222, and a third 1P3T switch 224, each coupled to a respective one of the first band contact 210, the second band contact 212, and the third band contact 214. Each of the throws of each respective 1P3T switch 220, 222, and 224 is connected to a respective antenna contact or pad 230, 232, 234 by a respective antenna bus bar 221, 223, 225. So, for example, the top throw of each 1P3T switch 220, 222, and 224 is connected to a first antenna contact 230 that is provided to a first antenna (denoted as “ANT1”) via a first antenna bus bar 221, the middle throw of each 1P3T switch 220, 222, 224 is connected to a second antenna contact 232 that is provided to a second antenna (denoted as “ANT2”) via a second antenna bus bar 223, and the bottom throw of each 1P3T switch 220, 222, 224 is connected to a third antenna contact 234 that is provided to a third antenna (denoted as “ANT3”) via a third antenna bus bar 225. It should be appreciated that rather than a 1P3T switch, three single pole single throw1P1T switches connected in parallel may be used to replace each of the 1P3T switches 220, 222, and 224. As shown, the ASM 200 may also include multiple shunt switches 240, 242, and 244 that may be closed (i.e., conducting) when the respective band contact to which it is connected is not being used.

The direct-connection ASM 200 includes 12 switch arms, 3 for each 1P3T switches 220, 222, and 223, and one additional switch arm for each of the three shunt switches 240, 242, and 244. The direct-connection ASM 200 exhibits low insertion loss due to only one switch arm in each switch path between each of the band contacts 210, 212, 214 and the corresponding one of the antenna contacts 230, 232, 234. For example, the insertion loss may be approximately 0.51 dB when implemented in SOI technology. Each band contact connects to a common antenna bus bar through a series switch, and a dedicated shunt switch is provided for a low impedance path to ground for isolation. Each off-arm proportionally adds to the off capacitance (Coff) of the direct-connection ASM 200. The direct-connection ASM 200 is versatile in that any dual antenna CA configuration can be supported. However, when implemented in SOI technology, it can consume a large die area. For example, the direct-connection ASM 200 consumes about 0.400 mm² when implemented in an SOI substrate. When implemented as a double-pole-three-throw (2P3T) switch (e.g., 3 bands, two antennas), a direct-connection ASM (not illustrated) would include only 9 switch arms (2 for each of 1P2T versions of the switches 220, 222, and 224), and then one additional arm for each of the three shunt switches 240, 242, and 244.

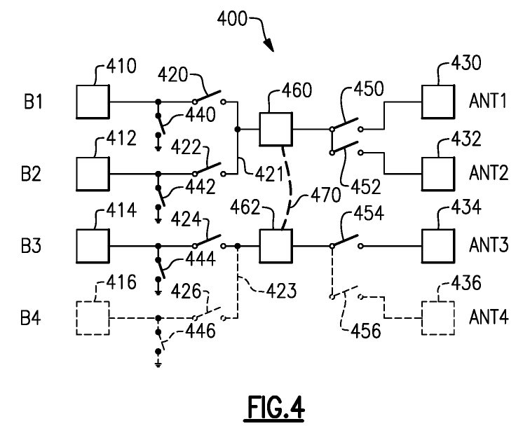

FIG. 3 illustrates an enabled type of antenna switch module (ASM) that might alternatively be used in a front end system, such as the front end system 80 of FIG. 1, according to an example. The enabled ASM 300 is configured as a 2P3T switch and can couple any one of three frequency band signals to any one of two different antennas. The enabled ASM 300 includes a first band contact or pad 310 for communicating (e.g., transmitting or receiving) signals in a first frequency band, a second band contact or pad 312 for communicating (e.g., transmitting or receiving) signals in a second frequency band, and a third band contact or pad 314 for communicating (e.g., transmitting or receiving) signals in a third frequency band. For example, the first band contact 310 may be configured to transmit and receive frequencies in bands 1, 3, 32, and 40, the second band contact 312 may be configured to transmit and receive frequencies in band 7, and the third band contact 314 may be configured to transmit and receive frequencies in bands 25, 66, and 30. While not shown in FIG. 3, the first band contact 310 may be connected to Band 1 and Band 3 duplexers, and to filters for each of bands 32 and 40. The second band contact 312 may be connected to a Band 7 duplexer, and the third band contact 314 may be connected to Band 25, 66, and 30 duplexers.

The enabled ASM 300 further includes a first single-pole-single-throw (1P1T) switch 320a, a second 1P1T switch 322a, and a third 1P1T switch 324a, each coupled to a respective one of the first band contact 310, the second band contact 312, and the third band contact 314. The throw of each respective 1P1T switch 320a, 322a, and 324a is connected to a first antenna contact or pad 330 by a first antenna bus bar 321. The enabled ASM 300 further includes a fourth 1P1T switch 320b, a fifth 1P1T switch 322b, and a sixth 1P1T switch 324b, each coupled to a respective one of the first band contact 310, the second band contact 312, and the third band contact 314. The throw of each respective 1P1T switch 320b, 322b, and 324b is connected to a second antenna contact or pad 332 by a second antenna bus bar 323. The 1P1T switches 320a, 320b, 322a, 322b, 324a, and 324b operate as band select switches to couple one of the band contacts or pads 310, 312, or 314 to a respective one of the two antenna bus bars 321 and 323.

As shown, the enabled ASM 300 may also include multiple shunt switches 340, 342, and 344 that may be closed (i.e., conducting) when the respective band contact to which it is connected is not being used, and multiple enable switches 350, 352, one for each antenna contact or pad 330, 332.

The enabled ASM 300 includes 11 switch arms, 6 for the band select switches 320a, 320b, 322a, 322b, 324a, and 324b, 3 for the shunt switches 340, 342, and 344, and two for the enable switches 350, 352. The enabled ASM 300 is conventionally used for de-prioritized bands (e.g., bands that may not be as widely used or adopted or have fallen out of use). A common enable switch (e.g., one of the enable switches 350 and 352) is used for each antenna connection. The enabled ASM 300 has a higher on-resistance (Ron) than the direct-connection ASM 200 due to two switches in series (e.g., the 1P1T switch 320a and the enable switch 350) in each switch path. A dedicated shunt switch is provided for a low impedance path to ground for isolation. The enabled ASM 300 can support dual antenna configurations, but because each antenna contacts 330 or 332 uses a dedicated intermediate node (i.e., the common bus bar node 321 or 323), it is not practical or efficient when used with 3 or more antennas (as in a 3PnTconfiguration). When implemented in SOI technology, it can also consume a large die area. For example, the enabled ASM 300 consumes about 0.539 mm² when implemented in an SOI substrate as a 2P3T switch (e.g., three bands, two antennas) and has an insertion loss of about 0.67 db.

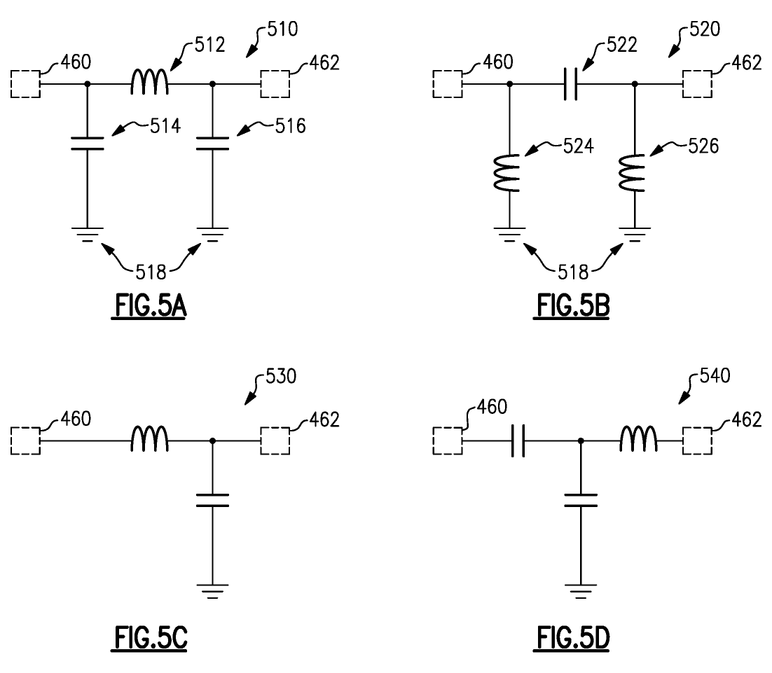

FIG. 4 illustrates a low-switch-count architecture for a multi-antenna antenna switch module in accordance with aspects of the present disclosure. The low-switch-count ASM 400 is configured as a 3P3T switch and can couple any one of three band contacts to any one of three different antennas. The low-switch-count ASM 400 includes a first band contact or pad 410 for communicating (e.g., transmitting or receiving) signals in a first frequency band, a second band contact or pad 412 for communicating (e.g., transmitting or receiving) signals in a second frequency band, and a third band contact or pad 414 for communicating (e.g., transmitting or receiving) signals in a third frequency band. For example, the first band contact 410 may be configured to transmit and receive frequencies in bands 1, 3, 32, and 40, the second band contact 412 may be configured to transmit and receive frequencies in band 7, and the third band contact 414 may be configured to transmit and receive frequencies in bands 25, 66, and 30. While not shown in FIG. 4, the first band contact 410 may be connected to Band 1 and Band 3 duplexers, and to filters for each of bands 32 and 40, the second band contact 412 may be connected to a Band 7 duplexer, and the third band contact 414 may be connected to Band 25, 66, and 30 duplexers. It should be appreciated that additional band contacts may be provided, for example, for bands 25, 66, 30, 34, 39, 11, etc.

The low-switch-count ASM 400 further includes a first single-pole-single-throw (1P1T) band switch 420, a second 1P1T band switch 422, and a third 1P1T band switch 424, each coupled to a respective one of the first band contact 410, the second band contact 412, and the third band contact 414. The throw of each respective 1P1T switch 420 and 422 is connected to a band bus bar 421 which is, in turn, connected to a first intermediate electrical node or contact 460. It should be appreciated that the band bus bar 421 is optional, and each throw may instead connect to the first intermediate electrical node or contact 460 through a separate path. The throw of the third 1P1T switch 424 is directly connected to a second intermediate electrical node or contact 462.

The first intermediate electrical node or contact 460 is connected to a first 1P1T antenna enable switch 450 that is connected to a first antenna contact or pad 430, and to a second 1P1T antenna enable switch 452 that is connected to a second antenna contact or pad 432. Each of the first and second antenna contact or pad 430, 432 may be coupled to a respective antenna (denoted as “ANT1” or “ANT2”). The first and second 1P1T antenna enable switches 450, 452 may alternatively be replaced with a single-pole-double-throw (1P2T) switch (not illustrated), in which the first throw of the 1P2T switch is connected to the first antenna contact or pad 430, and the second throw of the 1P2T switch is connected to the second antenna contact or pad 432. The second intermediate electrical node or contact 462 is connected to a third antenna contact or pad 434 via a third 1P1T antenna enable switch 454 (which may be considered a second switch, where the 1P1T antenna enable switches 450 and 452 are replaced with a 1P2T switch). The third antenna contact or pad 434 may be connected to a third antenna (denoted as “ANT3”). As shown, the low-switch-count ASM 400 may also include multiple shunt switches 440, 442, and 444 that may be closed (i.e., conducting) when the respective band contact to which it is connected is not being used, and open (i.e., non-conducting) when in use.

In some examples, the first and second intermediate electrical nodes or contacts 460, 462 may be interconnected via conductive routing within the ASM 400, or when, for example, the switches 420, 422, 440, 442, 450, and 452 are formed on one module (or die), and the switches 424, 444, and 454 on another module (or die), the intermediate electrical nodes 460, 462 may be connected by a multi-chip-module (MCM) conductive strap 470. The intermediate electrical nodes 460, 462 and the conductive strap 470 may include various inductive and/or capacitive elements to perform impedance matching between the intermediate electrical nodes 460, 462 at the various frequencies being used.

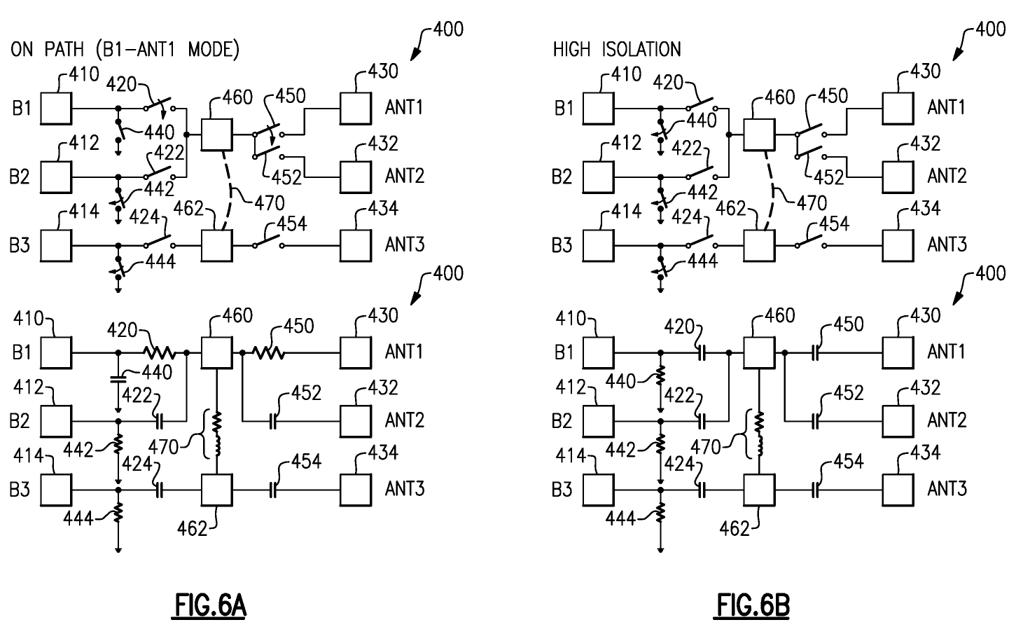

FIGS. 5A-5D illustrate various examples of the circuit diagram of a conductive strap of a low-switch-count ASM. Referring to FIG. 5A, in one example, the conductive strap 470 may include a pi network 510 including an inductor 512 coupled in series between the intermediate electrical nodes 460 and 462, with two shunt capacitors 514, 516 coupled to ground 518 on each side of the inductor 512. Alternatively, referring to FIG. 5B, a pi network 520 of the conductive strap 470 could include a capacitor 522 coupled in series between the intermediate electrical nodes 460 and 462, with two shunt inductors 524, 526 coupled to ground 518 on each side of the inductor 522. Various other types of impedance matching topologies may be used, including an L-network 530 (e.g., a series inductor with a shunt capacitor) as shown in FIG. 5C and a T-network 540 (e.g., a series combination of a capacitor and an inductor with a shunt capacitor to ground therebetween) as shown in FIG. 5D, including various topologies of inductors and capacitors. In some examples, the conductive strap 470 may be external to the module or die of the switches 420, 422, 440, 442, 450, and 452 and the module or die of the switches 424, 444, and 454.

The low-switch-count ASM 400 includes only 9 switch arms, 3 for the band switches 420, 422, and 424, 3 for the shunt switches 440, 442, and 444, and three for the antenna enable switches 450, 452, and 454. The low-switch-count ASM 400 may be used wherever minimal insertion loss is not required and size reduction is a priority, such as in supporting legacy bands that may be used in certain locations, but may not be in widespread use, or when simultaneous operation over different bands and multiple antennas is needed. The low-switch-count ASM 400 has a higher on-resistance (Ron) than the direct-connection ASM 200 due to two switches in series (e.g., the first band switch 420 and the first 1P1T antenna enable switch 450, or the third band switch 424 and the third 1P1T antenna enable switch 454), but is significantly smaller in area. The insertion loss of the low-switch-count ASM 400 may be approximately 0.81 dB when implemented in SOI technology (e.g., about 0.3 dB more than the direct-connection ASM 200 of FIG. 2).

The low-switch-count ASM 400 can support dual antenna configurations, albeit with fewer options than the direct-connect ASM 200 of FIG. 2. For example, because the first and second band contacts 410, 412 share the first intermediate electrical node 460, both the first and second band contacts 410, 412 cannot be simultaneously active. So, the first band contact 410, for example, may be coupled to only the first antenna pad 430, only the second antenna pad 432, both the first and second antenna pads 430, 432, only the third antenna pad 434, or all 3 antenna pads 430, 432, 434, but the first and second band contacts 410, 412 cannot be simultaneously active. The third band contact 414 may be simultaneously active with either of the first or second band contacts 410 or 412. When implemented in SOI technology, the ASM 400 can consume a significantly smaller area than either the direct-connect or enabled ASMs 200 or 300 of FIGS. 2 and 3. For example, the low-switch-count ASM 400 may consume about 0.290 mm² or less when implemented in an SOI substrate as a 3P3T switch (e.g., 3 bands, 3 antennas), with a size reduction of nearly 30%, compared to the direct-connection ASM 200 of FIG. 2.

Optionally, in some examples, the low-switch-count ASM 400 may additionally include a fourth band contact or pad and a fourth shunt switch coupled via a fourth band switch to the second intermediate electrical node or contact 462, as well as a fourth antenna enable switch and a fourth antenna contact or pad. This is shown in dotted line form in FIG. 4, where a fourth band contact or pad 416 is electrically coupled to a fourth band switch 426 that is, in turn, electrically coupled to the second intermediate electrical node or contact 462 via a second band bus bar 423. A fourth shunt switch 446 is coupled to the fourth band contact pad 416 and the fourth band switch 426. The second intermediate electrical node or contact 462 can be coupled to a fourth antenna contact or pad 436 via a fourth 1P1T antenna enable switch 456 (or a second antenna enable switch when the first and second 1P1T antenna enable switches 450 and 452 and the third and fourth 1P1T antenna enable switches 454 and 456 are formed as 1P2T switches, respectively). The third and fourth band contacts or pads 414, 416 may share a common band enable bus bar, i.e., the second band bus bar 423, in the same manner as the first and second band contacts 410, 412. Additional band contacts or pads and additional antenna contacts or pads may be added in other examples.

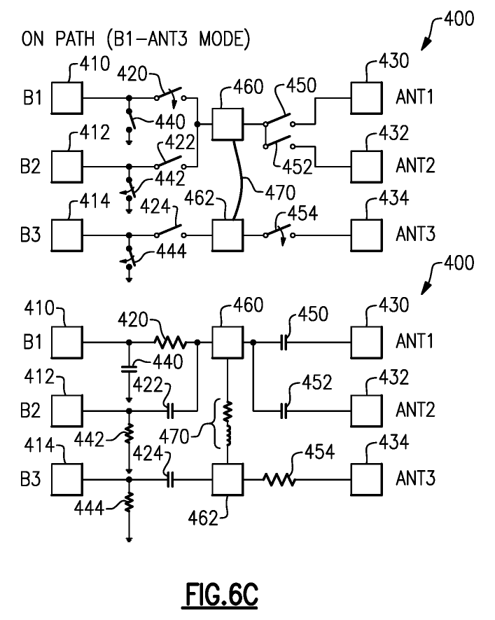

FIGS. 6A-6C illustrate circuit schematic and small-signal equivalent circuit diagrams of the low-switch-count ASM 400 in various configurations according to various examples. For example, the top illustration in FIG. 6A illustrates the low-switch-count ASM 400 configured to provide an RF signal from the first band (Band 1) contact or pad 410 to the first antenna (“ANT1”) contact or pad 430, or from the first antenna contact or pad 430 to the first band contact or pad 410. In this configuration, the first band switch 420 is closed, the first shunt switch 440 is open, the first antenna enable switch 450 is closed, the second and third shunt switches 442 and 444 are closed, the second and third band switches 422 and 444 are open, and the second and third antenna enable switches 452 and 454 are open. The small-signal equivalent circuit shown in the bottom illustration of FIG. 6A shows that the signal path between the first band contact or pad 410 and the first antenna contact or pad 430 behaves as a slightly resistive path.

FIG. 6B illustrates the low-switch-count ASM 400 configured in a high isolation mode where none of the switch paths between a band contact and an antenna contact are closed. In the high isolation mode, each of the shunt switches 440, 442, and 444 is closed, and all the other series switches (e.g., the band switches 420, 422, and 424 and the antenna enable switches 450, 452) are open. In this high isolation mode, the low-switch-count ASM 400 presents an off-capacitance of about 61 fF.

FIG. 6C illustrates the low-switch-count ASM 400 configured in a mode in which the first band (Band 1) contact or pad 410 is connected to the third antenna contact or pad 434 via the first and second intermediate electrical nodes 460 and 462. In this mode, an RF signal from the first band (Band 1) contact or pad 410 may be provided to the third antenna (“ANT1”) contact or pad 434, or an RF signal from the third antenna contact or pad 434 may be provided to the first band contact or pad 410. In this configuration, the first band switch 420 is closed, the first shunt switch 440 is open, the second and third band switches 422 and 424 are open, the third antenna enable switch 454 is closed, the second and third shunt switches 442 and 444 are closed, and the first and second antenna enable switches 450 and 452 are open. In this configuration, the signal path includes a slight amount of additional resistance (about .25 Ohms) and a small increased inductance (about 0.2 nH) due to the connection between the first and second intermediate electrical nodes 460, 462.

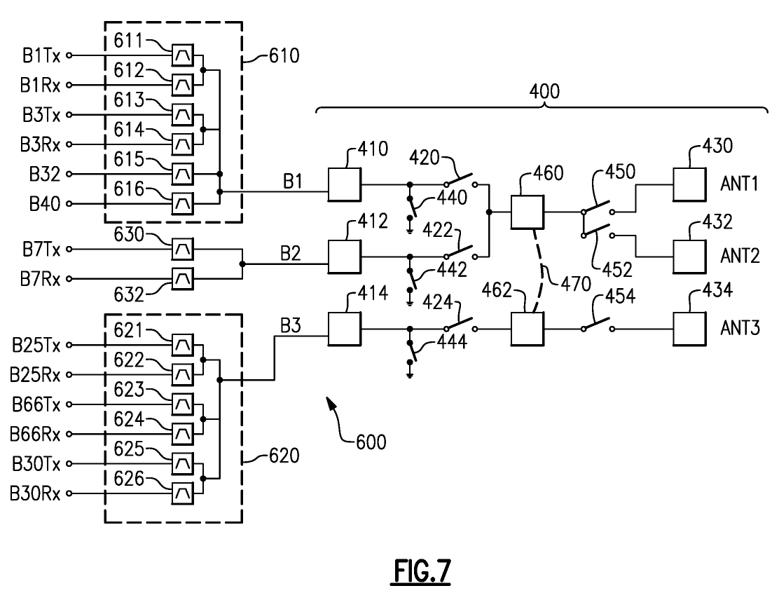

FIG. 7 illustrates the low-switch-count ASM 400 integrated into a multi-chip module 600 that includes multiple filter modules and multiple discrete filters. As shown, the first band contact or pad 410 is electrically coupled to a first filter module 610 that includes multiple duplexers as well as multiple discrete filters. For example, the first filter module 610 includes a first duplexer that includes a Band 1 transmit (Tx) filter 611 and a Band 1 receive filter (Rx) 612, as well as a second duplexer that includes a Band 3 transmit filter 613 and a Band 3 receive filter 614. The first filter module 610 further includes a Band 32 transmit and receive filter 615 and a Band 40 transmit and receive filter 616.

The second band contact or pad 412 is coupled to a third duplexer that includes a Band 7 transmit filter 630 and a Band 7 receive filter 632. The third band contact or pad 414 is coupled to a second filter module 620 that includes multiple duplexers. For example, the second filter module 620 may include a fourth duplexer that includes a Band 25 transmit filter 621 and a Band 25 receive filter 622, a fifth duplexer that includes a Band 66 transmit filter 623 and a Band 66 receive filter 624, and a sixth duplexer that includes a Band 30 transmit filter 625 and a Band 30 receive filter 626. The various transmit and receive filters and duplexers may include Surface Acoustic Wave (SAW) filters, Bulk Acoustic Wave (BAW) filters, or a combination of SAW and BAW filters.

Although not depicted in FIG. 7, those transmit filters in a mid-range of frequency may be switchably coupled to a mid-band power amplifier, while those transmit filters in a high-range of frequency may be switchably coupled to a high-band power amplifier. The various receive filters depicted in FIG. 7 may also be coupled to one or more low noise amplifiers. Various impedance matching components, such as inductors and capacitors, may be included in certain transmit or receive paths, as desired, which would be appreciated by those skilled in the art.

Any of the embodiments described above can be implemented in association with mobile devices such as cellular handsets. The principles and advantages of the embodiments can be used for any systems or apparatus, such as any uplink wireless communication device, which could benefit from any of the embodiments described herein. The teachings herein are applicable to a variety of systems. Although this disclosure includes example embodiments, the teachings described herein can be applied to a variety of structures. Any of the principles and advantages discussed herein can be implemented in association with RF circuits configured to process signals having a frequency in a range from about 1 GHz to 5 GHz, such as in a frequency range from about 1 GHz to 3 GHz.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

What is claimed is:

1. An antenna switch module comprising:
a plurality of band contacts including a first band contact to communicate over at least one first frequency band, a second band contact to communicate over at least one second frequency band, and a third band contact to communicate over at least one third frequency band;
a plurality of antenna contacts including a first antenna contact, a second antenna contact, and a third antenna contact;
a plurality of intermediate electrical contacts including a first intermediate electrical contact and a second intermediate electrical contact;
a plurality of band switches including a first band switch coupled between the first band contact and the first intermediate electrical contact, a second band switch coupled between the second band contact and the first intermediate electrical contact, and a third band switch coupled between the third band contact and the second intermediate electrical contact; and
a plurality of antenna switches including a first antenna switch coupled between the first intermediate electrical contact and the first antenna contact, a second antenna switch coupled between the first intermediate electrical contact and the second antenna contact, and a third antenna switch coupled between the second intermediate electrical contact and the third antenna contact.

2. The antenna switch module of claim 1 further comprising an electrical conductor electrically coupling the first intermediate electrical contact and the second intermediate electrical contact.

3. The antenna switch module of claim 2 wherein the first intermediate electrical contact is disposed on a first module, the second intermediate electrical contact is disposed on a second module, and the electrical conductor is an electrically conductive strap.

4. The antenna switch module of claim 3 wherein the electrically conductive strap includes a multi-chip-module (MCM) strap external to the first module and the second module.

5. The antenna switch module of claim 3 wherein the electrically conductive strap includes an impedance matching network.

6. The antenna switch module of claim 5 wherein the impedance matching network includes one of a pi-network, an L-network, or a T-network.

7. The antenna switch module of claim 2 wherein the first intermediate electrical contact and the second intermediate electrical contact are disposed on a same module, and the electrical conductor is formed by electrically conductive routing within the module.

8. The antenna switch module of claim 7 wherein the electrically conductive routing includes an impedance matching network.

9. The antenna switch module of claim 8 wherein the impedance matching network includes one of a pi-network, an L-network, or a T-network.

10. The antenna switch module of claim 2 further comprising a plurality of shunt switches including a first shunt switch coupled to ground and between the first band contact and the first intermediate electrical contact, a second shunt switch coupled to ground and between the second band contact and the first intermediate electrical contact, and a third shunt switch coupled to ground and between the third band contact and the second intermediate electrical contact.

11. The antenna switch module of claim 10 wherein the antenna switch module includes only 9 switch arms.

12. The antenna switch module of claim 11 wherein the antenna switch module is implemented in silicon on insulator technology and occupies an area of approximately 0.290 mm² or less.

13. The antenna switch module of claim 2 further comprising:
a fourth band contact to communicate over at least one fourth frequency band;
a fourth antenna contact;
a fourth band switch coupled between the fourth band contact and the second intermediate electrical contact; and
a fourth antenna switch coupled between the second intermediate electrical contact and the fourth antenna contact.

14. The antenna switch module of claim 2 further comprising a plurality of duplexers coupled to the first band contact, the plurality of duplexers including duplexers for at least bands 1 and 3, or bands 25, 66, and 30.

15. The antenna switch module of claim 14 wherein the antenna switch module is implemented in a multi-chip module and wherein the multi-chip module includes at least one power amplifier and at least one low noise amplifier.

16. The antenna switch module of claim 2 wherein the third band switch is directly coupled to the second intermediate electrical contact.

17. A method of operating an antenna switch module, the method comprising:
coupling a first band contact to a first antenna contact through a first intermediate electrical contact, the first intermediate electrical contact switchably coupled to the first antenna contact and a second antenna contact, including
operating a first band switch in a conducting state, the first band switch coupled between the first band contact and the first intermediate electrical contact, and
operating a first antenna switch in a conducting state, the first antenna switch coupled between the first intermediate electrical contact and the first antenna contact; and
coupling the first band contact to a second antenna contact through the first intermediate electrical contact and a second intermediate electrical contact, including
operating a second antenna switch in a conducting state, the second antenna switch coupled between the second intermediate electrical contact and the second antenna contact.

18. The method of claim 17 further comprising:
providing a conductive strap including an impedance matching circuit; and
coupling the first intermediate electrical contact to the second intermediate electrical contact using the conductive strap.

19. The method of claim 17 wherein coupling the first band contact to the first antenna contact further includes
operating a third band switch in a non-conducting state, the third band switch coupled between a third band contact and the first intermediate electrical contact.

20. The method of claim 17 wherein coupling the first band contact to the first antenna contact further includes
operating a first shunt switch in a non-conducting state, the first shunt switch coupled between the first band contact and a reference node.
